(19) United States
(12) Patent Application Publication
(10) Pub. No.: US 2008/0258901 A1
(43) Pub. Date: Oct. 23, 2008

(54) Apparatus and Method for Verifying Procedure Compliance

(76) Inventors: Kevin Rubey, Ventura, CA (US); Gavriel Meron, Petah Tikva (IL)

Correspondence Address: Pearl Cohen Zedek Latzer, LLP, 1500 Broadway, 12th Floor, New York, NY, 10036, US

(21) Appl. No.: 12/066,909

(22) PCT Filed: Sep. 4, 2006
(86) PCT No.: PCT/IL2006/001023

§ 371 Date: Jun. 17, 2008

Related U.S. Application Data
(60) Provisional application No. 60/716,955, filed on Sep. 15, 2005.

(51) Int. Cl. G08B 23/00

(52) U.S. Cl. 340/502

(57) ABSTRACT

A device and method for verifying compliance of a patient preparing colon preparation prior to for example a colonoscopy diagnosis. One or more reminders may be issued to the patient to perform an activity for colon preparation. A confirmation may be received responding to the reminder and the confirmation may be recorded. Information of activities recorded on the device may be provided for surveying in order to evaluate the readiness of colon preparation.

### FIELD OF THE INVENTION

The present invention relates to colonoscopy or other diagnosis. In particular, it relates to compliance verification of colon preparation by a patient before diagnosis.

### BACKGROUND OF THE INVENTION

Colonoscopy diagnosis is a medical procedure that may take pictures of the colon (large intestine) from, for example, the lowest part, the rectum, all the way to the lower end of the small intestine of a patient. The images are displayed on a screen and diagnosed, for example, by a physician to identify possible or potential colon and bowel diseases, including, for example, polyps, diverticulosis, and cancer.

In order to get clear and accurate pictures of the colon, a good pre-diagnosis colon preparation may be needed. The preparation of the colon may take, for example, up to 8 to 24 or more hours during which the patient may be required to follow a certain preparation procedure, or protocol selected or customized by a physician. For example, the patient may be asked to take laxatives or other oral agents at home to clear stools from the colon, and/or drink certain types of fluid, at a series of predetermined time intervals. It is understandable that some patients may not strictly follow the required preparation procedure due to reasons such as, for example, that the patient may be simply absent-minded or forgetful. Furthermore, before performing colonoscopy diagnosis of the patient, the physician may also need to know, aside from any required preparation taken by the patient, what other types of activities the patient had prior to the diagnosis.

### SUMMARY OF THE INVENTION

Embodiments of the present invention provide a device and method for verifying compliance of a patient performing colon preparation prior to a colonoscopy diagnosis. The device and method may include issuing a reminder to the patient to perform an activity for colon preparation; receiving a confirmation responding to the reminder; and recording the confirmation.

According to an embodiment of the invention, the device and method may include issuing one or more subsequent reminders after a pre-selected time period elapses from the time the reminder was issued if the confirmation is not received.

According to an embodiment of the invention, the device and method may also include recording a non-compliance indication if the confirmation is not received by a pre-set time period before a subsequent colon preparation activity becomes due.

According to an embodiment of the invention, the activity for colon preparation may be selected from a pre-defined set of activities; some of the activities may be required for colon preparation; and some of the activities may be required for recordation if performed by the patient.

According to an embodiment of the invention, the device and method may include providing recorded information on activities for evaluating colon preparation.

According to an embodiment of the invention, providing recorded information may include uploading the recorded activities from a recorder to a computer.

According to an embodiment of the invention, the device and system may include selecting a colon preparation protocol for the patient.

According to an embodiment of the invention, selecting the colon preparation protocol may include downloading a pre-defined set of activities to be performed by the patent.

According to an embodiment of the invention, the device may be a portable device, and may be self-contained, and may be operated by a battery.

According to some embodiments of the present invention, there may also be provided a colon preparation recorder comprising:
a controller to issue one or more reminders to a patient to perform an activity for colon preparation;
a user interface to receive a confirmation responding to the reminders; and
a data recording device to record the confirmation.

According to some embodiments, the interface may comprise at least one button for the user to enter the confirmation. The interface may comprise at least one microphone for the user to enter the confirmation verbally. The interface may comprise at least one speaker to alert the user about the activity. The interface may comprise at least one vibration element to alert the user about the activity.

According to some embodiments, the activity is selected from a set of pre-defined activities, and wherein the activity is related to a colon preparation procedure. The interface may comprise at least one screen to display the set of pre-defined activities.

According to some embodiments, there may be provided a method for verifying compliance of patient activity prior to a medical procedure on a patient, the method comprising:

recording one or more activities on a recorder; and

evaluating readiness for the procedure by surveying activities recorded on the recorder.

According to some embodiments, there may also be provided a device for verifying compliance of patient activity prior to a medical procedure on a patient, the device comprising:

a unit to prompt a patient to follow a protocol; and

a unit to record one or more patient activities.

### BRIEF DESCRIPTION OF THE DRAWINGS

The subject matter regarded as the invention is particularly pointed out and distinctly claimed in the summary of the specification. The invention, however, both as to organization and method of operation, together with objects, features and advantages thereof, may be best understood by reference to the following detailed description when read with the accompanied drawings in which:

FIG. 1A is a schematic illustration of a colon preparation recorder in accordance with an illustrative embodiment of the present invention;

FIG. 1B shows internal modules of the colon preparation recorder of FIG. 1B;

FIG. 2 is a schematic illustration of a patient wearing a colon preparation recorder in accordance with an illustrative embodiment of the present invention;

FIG. 3 is a schematic illustration of a physician downloading from a computer, procedure related protocols for colon preparation to a colon preparation recorder, and/or uploading from the colon preparation recorder an activity record to the computer in accordance with an illustrative embodiment of the present invention; and

FIG. 4 is a schematic block diagram illustration of a method for recording activities during a colon preparation period prior to a colonoscopy diagnosis of a patient in accordance with an illustrative embodiment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

The following description is presented to enable one of ordinary skill in the art to make and use the invention as provided in the context of a particular application and its requirements. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the following detailed description, numerous specific details are set forth in order to provide a thorough understanding of the present invention. However, it will be understood by those skilled in the art that the present invention may be practiced without these specific details. In other instances, well-known methods, procedures, and components have not been described in detail so as not to obscure the present invention.

Embodiments of the present invention provide a device and a method for verifying compliance of colon preparation prior to a colonoscopy diagnosis of a patient. In other embodiments, the procedure to be performed need not be colonoscopy; methods and devices according to embodiments of the present invention may include verifying compliance of patient activity prior to any other medical procedure.

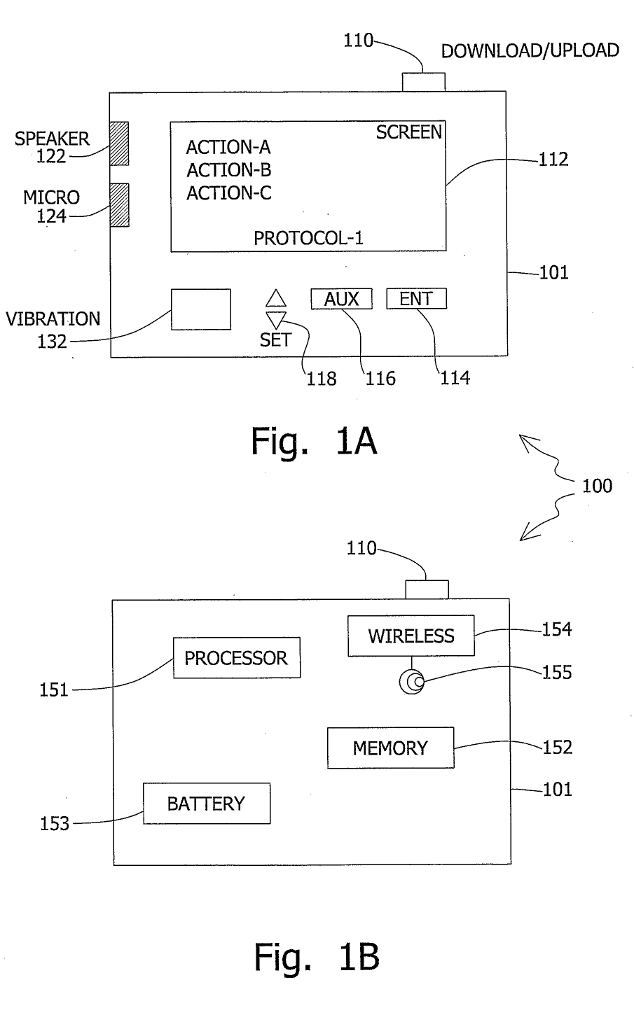

Reference is made to FIGS. 1A and 1B, which are schematic illustrations of a colon preparation recorder (CPR) 100 in accordance with an illustrative embodiment of the present invention.

According to an illustrative embodiment of the invention, CPR 100 may be a portable device and self-contained in a container or case 101. CPR 100 may be similar both in size and in weight to, for example, a wrist-worn watch, a cell phone, and/or a personal digital assistant (PDA). However, the invention is not limited in this respect and CPR 100 may have different sizes and weights from those items identified above.

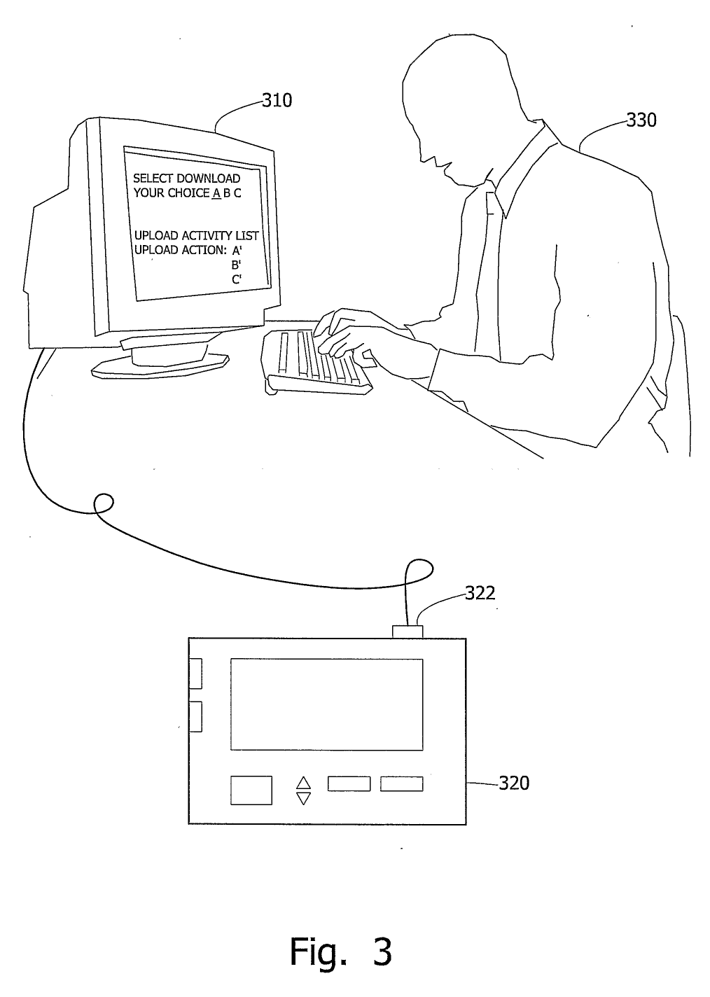

According to an illustrative embodiment of the invention, CPR 100 may have at least one data input/output port, for example, port 110. Port 110 may be used to interconnect with other data processing devices, for example, a personal computer (PC) 310 (see FIG. 3) for downloading and uploading data or information relating to colonoscopy diagnosis and/or other medical procedures. For example, a colon preparation protocol may be downloaded to CPR 100 and activity recorded in CPR 100, which may be entered by a patient during a colon preparation period, may be uploaded to the PC 310, as described in detail below with reference to FIG. 3. Port 110 may be for example a USB port, serial port, or other suitable type of data port. In addition, CPR 100 may also include a wireless communication port 154, which may perform the function of data input/output port 110 as described above. Wireless communication port 154 may include, for example, a transceiver and an antenna, e.g., antenna 155.

CPR 100 may include a data processor 151 and a memory 152. Processor 151 may include a controller able to issue reminders to a patient for performing a colon preparation activity. Processor 151 may also include a recording mechanism or recording device able to record confirmations entered by the patient on a memory 152. Memory 152 may be a Random Access Memory (RAM) or other suitable data storage media, and may be a partially or completely removable and/or pluggable memory device (e.g., a “DiskOnKey®”). CPR 100 may be implemented, for example, as part of a personal digital assistant or other unit, or may be a unit with dedicated functionality. CPR 100 may be battery operated and may include a battery or battery unit 153.

According to an illustrative embodiment of the invention, CPR 100 may also include a displaying screen 112 and one or more buttons or controls, for example, enter button 114 (ENT), auxiliary button 116 (AUX), and select button 118 (SEL), as part of an interactive user interface between CPR 100 and a patient who uses CPR 100. It will be appreciated by a person skilled in the art that screen 112 may also provide one or more touch or controls buttons for data and/or command input by the patient. In addition, CPR 100 may also include a speaker 122 and/or a microphone 124 as part of the interface. Speaker 122 may be used to audibly alert a patient to perform a certain activity following a pre-determined preparation protocol. The patient, after finishing the required activity or simply as a response to the alert, for example, may record a verbal or other audio confirmation to CPR 100 by speaking or making a sound to microphone 124. CPR 100 may additionally include a vibration element 132 (VIB) which may be used to alert the patient, just as screen 112 and/or speaker 122 do, to a certain activity by self-vibration.

It will be appreciated by a person skilled in the art that the present invention may include other interaction or interface components. For example, CPR 100 may use a flashing light to alert the patient to a certain activity.

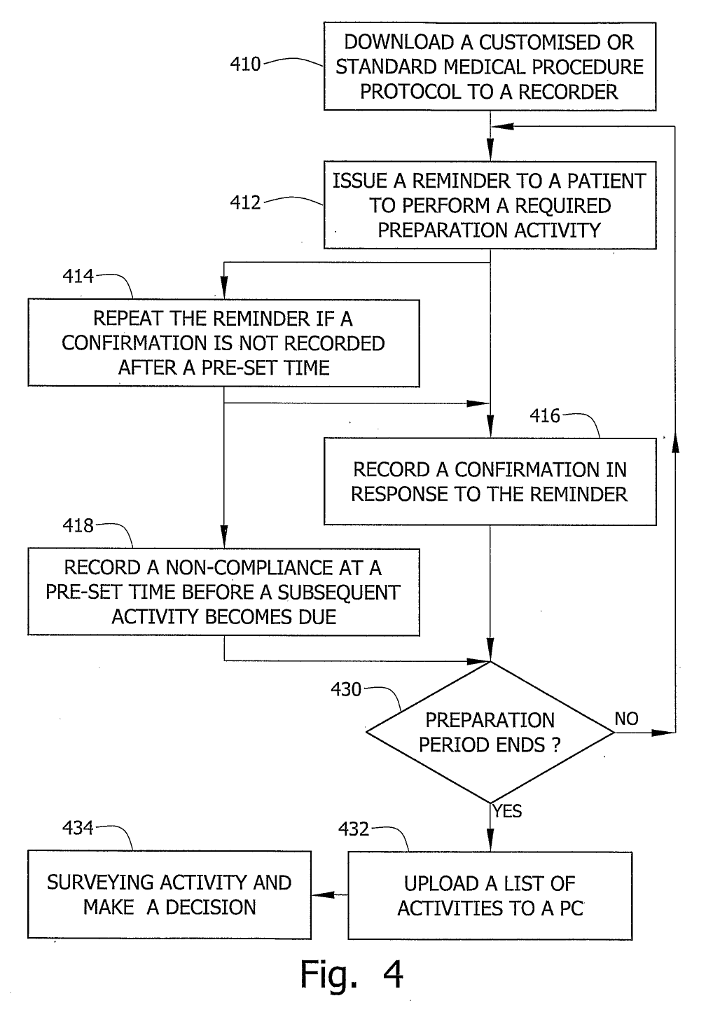

According to an illustrative embodiment of the invention, CPR 100 may also include an internal clock which may record, for example, date and time when an entry is made by a patient or automatically by CPR 100 as described below in detail with reference to FIG. 4. CPR 100 may also send out an alert to the patient based on the time recorded by the internal clock.

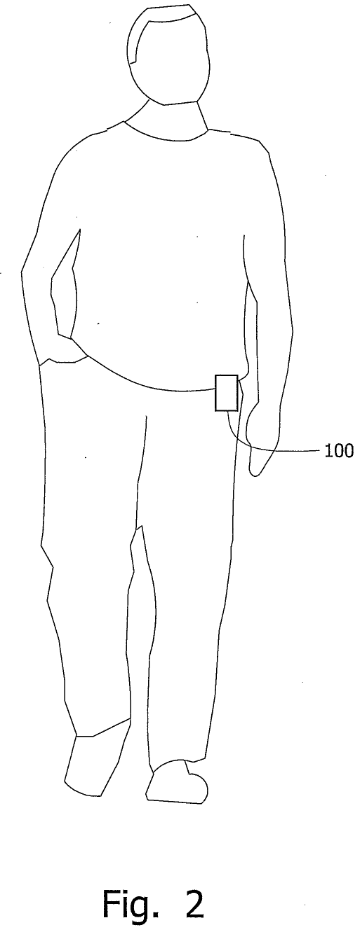

Reference is made to FIG. 2, which is a schematic illustration of a patient wearing a colon preparation recorder (CPR) in accordance with an illustrative embodiment of the present invention. The CPR is shown to be attached to a belt of the patient. However, the invention is not limited in this respect. For example, the CPR may be worn on a wrist or hung on a lanyard around the neck of the patient. Furthermore, the CPR may be put inside a pocket of the clothes that the patient is wearing, or in a bag that the patient is carrying, or located within a vicinity of the patient so long as it can communicate with the patient either audibly, and/or visually, and/or via a vibration signal.

According to one illustrative embodiment, the CPR device for alerting a patient and/or recording patient compliance with preparation procedures may be included in a receiving unit of a capsule endoscope system. For example, the CPR may be incorporated into or attached to a receiver/recorder device that is used to receive image data transmitted from a capsule endoscope, as is known in the art. Such a capsule endoscope system may be similar to the system, for example, described in embodiments of U.S. Pat. No. 5,604,531 to Iddan et al and/or U.S. Pat. No. 7,009,634 to Iddan et al, both of which are assigned to the common assignee of the present invention and both of which are incorporated herein by reference in their entirety. According to embodiments of the invention, the receiver/recorder device, having incorporated the CPR device, may be worn on a belt by a patient.

Furthermore, a device for prompting and/or recording patient activities, according to further embodiments of the invention, may be part of, or incorporated into, or attached to other suitable devices or systems, e.g., a cellular phone or other portable devices.

Reference is made to FIG. 3, which is a schematic illustration of a physician 330 downloading from a personal computer 310 procedure related protocols for colon preparation to the colon preparation recorder 100, and/or uploading from the colon preparation recorder activity record to the personal computer 310 in accordance with an illustrative embodiment of the present invention.

According to an illustrative embodiment of the invention, a data processing device, for example, the personal computer (PC) 310, may be connected with the CPR 100. The connection may be made between an input/output port 322 of CPR 320, and a data communication port 312 of PC 310. However, the invention is not limited in this respect, and the connection may be made remotely. In other words, wireless connection maybe made between CPR 100 (via wireless communication port 154 in FIG. 1) and PC 310, and the wireless connection may be made directly or through a wireless network or any other suitable technologies. PC 310 may be a Windows-based PC, and according to an illustrative embodiment of the invention, may be installed with software designed to help a physician verify compliance of colon preparation by a patient. For the convenience of description, the software will be referred to hereinafter as “Colon Preparation Readiness Evaluation (CPRE) software”, or CPRE software. Other types of computers or dedicated workstations may be used to connect to CPR 100 with other types of software.

According to an illustrative embodiment of the invention, physician 330 may select a default colon preparation protocol or one of a list of protocols available from the CPRE software, or may create a customized protocol through the CPRE software. Physician 330 may then download the protocol to CPR 100, and ask a patient to use CPR 100 during a preparation period to record all the activities that may be relevant to a colonoscopy diagnosis or other procedures. According to some embodiments reminders or prompts to a patient may be sent or issued from a remote location, e.g., through cellular or other appropriate technology.

At the end of the colon preparation period but prior to performing the colonoscopy diagnosis, physician 330 may upload activities recorded on CPR 100 to PC 310. Physician 330 may then evaluate, based on the activities recorded in CPR 100 and displayed on the screen of PC 310, whether the patient is ready to proceed to the colonoscopy or other diagnosis.

Reference is now made to FIG. 4, which is a schematic block diagram illustration of a method for recording activities during a colon preparation period prior to a colonoscopy diagnosis of a patient in accordance with an illustrative embodiment of the present invention.

According to one embodiment as indicated at block 410, a physician or a person who helps administrate the colonoscopy diagnosis, for example, a nurse, may select and download a colon preparation protocol from, for example, computer 310 to CPR 100 which is to be carried by a patient during a colon preparation period. The protocol may be a default protocol, or one from a list of standard protocols provided by the CPRE software installed in the computer. The protocol may also be a customized protocol prepared by the physician or nurse specifically for the patient.

According to one embodiment of the invention, the download may be made prior to a patient performing the required preparation procedure. According to another embodiment of the invention, the download and/or any modification to a previously downloaded protocol may be performed while the patient is already in the preparation stage and the download and/or modification may be made through, e.g., a wireless communication network, from a personal computer or workstation of the physician directly to the CPR 100 worn by the patient with or without the awareness the patient.

As indicated at block 412, at one or more pre-determined times which may be dictated by the protocol, the CPR 100 may issue or give the patient a reminder, audibly and/or visually and/or via a vibration signal, to take a required colon preparation activity such as, for example, drinking a prescribed fluid to help clear stools. The required activity may be displayed, for example, on the screen 112, of the CPR 100. However, the invention is not limited in this respect. For example, the reminder may be issued or given to the patient audibly through a speaker, for example, speaker 122, or through a vibration signal generated by a vibration element, for example, vibration element 132. According to one embodiment of the invention, instructions such as, for example, how to perform the activity may also be provided to the patient through the display screen 112.

As indicated at block 414, if a pre-selected time period or interval, for example, 5 minutes, 10 minutes, or 15 minutes, has elapsed and no confirmation of response to the reminder, or confirmation that the activity has been performed, has been received and recorded by the CPR 100, which may be entered by the patient, the CPR 100 may repeat or re-issue the reminder, audibly and/or visually and/or via a vibration signal, to the patient. The types of confirmation may include, for example, that the patient has taken the required activity, or has partially taken the activity, or will not take the activity. Other types of confirmations may also be possible. The CPR 100 may repeat sending or issuing the same reminder, at the same time interval or a different time interval, to alert the patient to take the required activity until a confirmation is recorded or entered, or until a certain time period has expired. Protocols and patient responses (or lack of responses) may be recorded, for example, on memory 152 in the CPR 100. In other embodiments a memory need not be used and patient input may be transmitted online to a remote station and recoded there.

As indicated at block 416, the patient, following the first reminder or one of the subsequent reminders given or issued by the CPR 100, may enter a confirmation to the CPR 100, or to a remote recording device wirelessly via the CPR 100, indicating that the required colon preparation activity has been taken care of. For example, the activity has either been taken or partially taken or ignored. The confirmation may be entered and recorded by the CPR 100 at least by a pre-set time period prior to a subsequent colon preparation activity becomes due.

As indicated at block 418, if no confirmation is recorded by the pre-set time prior to a subsequent colon preparation activity becomes due, the CPR 100 may proceed to record automatically, or send a recordation signal to a remotely located recording device wirelessly, a non-compliance indication with regard to this particular colon preparation activity.

During the colon preparation period, the patient may perform certain activities which are listed in a pre-defined set of activities in the CPR 100. The activity may be required for colon preparation, or may not be required for the purpose of colon preparation but required for recordation so that the physician may become aware of the activity later. For example, a patient may perform an activity prior to the CPR 100 issuing a reminder. After the activity, the patient may record the activity in the CPR 100. The CPR 100 may display a list of activities which are pre-downloaded by the physician during protocol preparation. The patient may review the list of activities on a display, e.g., display 112 of CPR 100, select the activity he/she performed, and enter a confirmation. According to some embodiments of the invention activities, pre-defined or not, may include stopping or starting a certain diet, in-taking a laxative, in-taking certain liquids and other suitable activities for colonoscopy preparation. Other activities may be required or pre-defined for procedures other than colonoscopy.

As indicated at block 430, if the colon preparation period has not expired yet, the CPR 100 may continue to provide the patient with reminders for taking activities when the activities become due, and the patient may enter confirmation responding to the reminder voluntarily, as indicated above at block 416.

After the colon preparation period has passed, the patient may bring the CPR 100 to the health professional 330. As indicated at block 432, the health professional 330 may upload the list of activities and responses that have been recorded in the CPR 100 to the computer 310 or to a dedicated work station. As indicated at block 434, the physician may survey all the activities taken by the patient, either required or non-required by the colon preparation protocol, and may make an assessment as to whether to proceed further with, for example, the colonoscopy diagnosis. The uploading may be by a data link (e.g., a wired connection between the CPR 100 and the computer 310) or for example by physically transferring a storage device (e.g., DiskOnKey®). Other uploading methods, such as, for example, a direct wireless communication link or a wireless link through an existing wireless network may be used.

According to one embodiment of the invention, the physician need not upload the recorded activities, and may survey the recorded activities through the display screen, for example, screen 112, of the CPR and make an appropriate medical judgment regarding further diagnosis.

According to some embodiments of the invention a prompting and/or recording device as described above may be used in other typically medical or preparatory procedures, such as by pre-labor patients to record the progression of contractions prior to arriving at a hospital for delivery, or by patients required to take numerous pills periodically, etc. By using a device according to embodiments of the invention a patient may record (with or without being prompted) activities or occurrences over a period of time for a physician's review at a later time.

The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

1-20. (canceled)

21. A method for verifying compliance of a patient performing colon preparation prior to a colonoscopy diagnosis, the method comprising:
issuing a reminder to the patient to perform an activity for colon preparation, said reminder issued through a colon preparation recorder;
receiving from the patient a response to the reminder through a user interface of the colon preparation recorder; and
recording the response.

22. The method of claim 21, comprising:
issuing one or more subsequent reminders after a pre-selected time period elapses from the time the reminder was issued if the response is not received.

23. The method of claim 22, comprising:
recording a non-compliance indication if the response is not received by a pre-set time period.

24. The method of claim 21, wherein the activity for colon preparation is selected from a pre-defined set of activities.

25. The method of claim 21, further comprising:
providing recorded information on activities for evaluating colon preparation.

26. The method of claim 25, wherein providing recorded information comprises uploading the recorded activities from a recorder to a computer.

27. The method of claim 21, further comprising:
selecting a colon preparation protocol for the patient.

28. The method of claim 27, wherein selecting the colon preparation protocol comprises downloading a pre-defined set of activities to be performed by the patient.

29. The method of claim 21, wherein the issuing, receiving, and recording is performed by a portable device.

30. A colon preparation recorder comprising:
a controller to issue one or more reminders to a patient to perform an activity for colon preparation;
a user interface to receive a response to the reminders; and
a data recording device to record the response.

31. The colon preparation recorder of claim 30, wherein the interface comprises at least one button for the user to enter the response.

32. The colon preparation recorder of claim 30, wherein the interface comprises at least one microphone for the user to enter the response verbally.

33. The colon preparation recorder of claim 30, wherein said interface comprises at least one speaker to alert the user about the activity.

34. The colon preparation recorder of claim 30, wherein said interface comprises at least one vibration element to alert the user about the activity.

35. The colon preparation recorder of claim 30, wherein the activity is selected from a set of pre-defined activities, and wherein the activity is related to a colon preparation procedure.

36. The colon preparation recorder of claim 35, wherein the user interface comprises at least one screen to display the set of pre-defined activities.

37. The colon preparation recorder of claim 30, wherein said colon preparation recorder is included in a receiving unit of a capsule endoscope system.
